(19) United States
(12) Patent Application Publication
(10) Pub. No.: US 2024/0336744 A1
(43) Pub. Date: Oct. 10, 2024

(54) BIOPLASTIC AND METHOD OF MAKING THEREOF

(71) Applicant: Boulos & Cooper Labs Pty Ltd, Gwelup, Western Australia (AU)

(72) Inventors: Ramiz Boulos, Gwelup, WA (AU); Berkay Ozcelik, Frankston North, Victoria (AU)

(73) Assignee: Boulos & Cooper Labs Pty Ltd, Gwelup, Western Australia (AU)

(21) Appl. No.: 18/580,745

(22) PCT Filed: Jul. 18, 2022
(86) PCT No.: PCT/AU2022/050756

§ 371 Date: Jan. 19, 2024

(30) Foreign Application Priority Data
Jul. 19, 2021 (AU) 2021902220

(51) Int. Cl. C08H 1/06; C05F 3/00; C05G 5/40; C08H 8/00; C08J 3/24; C08K 3/36; C08K 5/053; C08L 89/04; C08L 91/06; C08L 99/00

(52) U.S. Cl. CPC C08H 1/06; C05F 3/00; C05G 5/40; C08H 8/00; C08J 3/246; C08K 3/36; C08K 5/053; C08L 89/04; C08L 91/06; C08L 99/00; C08J 2389/04; C08J 2399/00; C08J 2405/08; C08L 2201/06

(57) ABSTRACT

A method is for forming a bioplastic material. The method provides a mixture comprising a keratinaceous substrate, and a secondary biopolymer substrate that includes one or more of an amine, hydroxyl and carboxyl group. The method also includes crosslinking the keratinaceous substrate and the secondary biopolymer substrate to form the bioplastic material. A crosslinking agent may be used.

### FIELD

This disclosure relates to the formation of biodegradable bioplastics.

### BACKGROUND

To help combat global pollution, there is a growing push to transition away from oil-based and non-degradable plastics toward biodegradable plastic materials. Biodegradable plastic materials are known as bioplastics. This transition requires the discovery and adoption of new feedstocks to make new plastic materials with properties similar to existing plastics.

To become more carbon neutral, the use of biodegradable plastic materials should also not rely on fossil fuel-based feedstocks. For this reason, many biodegradable plastic materials are formed from plant-based feedstocks. However, clearing land to allow the development of plantations may hinder the reduction in the environmental impact of using biodegradable plastics. The use of plant-based feedstocks may also place pressure on vegetation. One way to combat this problem is to convert waste streams into biodegradable plastic feedstocks.

Keratin is a fibrous structural protein that is an important structural component of hair, nails, horn, hoofs, wool, feathers, and epithelial cells in the outermost layers of the skin. Keratin waste from sources such as animal hair is underutilised as a feedstock, and waste wool is a potential source of keratin feedstocks. Notably, not all wool is suitable for use in the textile industry, not all sheep farms harvest wool, and, therefore, developing uses for waste wool is important in reducing this biowaste. Wool and other animal fibres also have the advantage of being a renewable feedstock for developing sustainable technologies for the future.

Keratin is extremely difficult to extract from hair, wool, and the like due to its low solubility and natural crosslinked nature compounded by its hierarchical structure. Methods for solubilising keratin have included the steps of pulverising keratinaceous substrates such as hair, wool, etc., hydrolysing the pulverised keratinaceous substrate, and then solubilising the keratin materials. These methods require high energy inputs and/or hazardous steps and hazardous chemicals, and do not always lead to a high-yielding process that allows for commercially viable feedstocks.

It is to be understood that, if any prior publication is referred to herein, such reference does not constitute an admission that the publication forms part of the common general knowledge in the art, in Australia, or any other country.

### SUMMARY

A method of forming a bioplastic material, comprising:
providing a mixture formed by:
   dissolving a keratinaceous substrate in a eutectic mixture, and
   adding a secondary biopolymer substrate that includes one or more of an amine, hydroxyl and carboxyl group to the eutectic mixture to form a mixture of the keratinaceous substrate and the secondary biopolymer substrate; and
crosslinking the keratinaceous substrate and the secondary biopolymer substrate to form the bioplastic material.

An embodiment provides a method of forming a bioplastic material, comprising:
providing a mixture comprising:
   a keratinaceous substrate, and
   a secondary biopolymer substrate that includes one or more of an amine, hydroxyl and carboxyl group; and
crosslinking the keratinaceous substrate and the secondary biopolymer substrate to form the bioplastic material.

A crosslinking agent may be included in the mixture.

An embodiment provides a method of forming a bioplastic material, comprising:
providing a mixture comprising a keratinaceous substrate, a secondary biopolymer, or proteinaceous and/or polysaccharide substrate and a crosslinking agent; and
crosslinking the keratinaceous substrate and/or the secondary proteinaceous and/or polysaccharide substrate with the crosslinking agent to form the bioplastic material.

Crosslinking may be facilitated by adjusting a pH of the mixture.

An embodiment provides a method of forming a bioplastic material, comprising:
(i) providing a mixture comprising a keratinaceous substrate;
(ii) adding a secondary biopolymer, or proteinaceous and/or polysaccharide, substrate and optionally a crosslinking agent to the mixture in (i); and
(iii) adjusting a pH of the mixture to promote crosslinking of the keratinaceous substrate and/or the secondary proteinaceous substrate to form the bioplastic material.

Step (iii) may be performed before step (ii).

An embodiment provides a method of forming a bioplastic material, comprising:
(i) providing a mixture comprising one of a keratinaceous substrate, a secondary biopolymer, or proteinaceous and/or polysaccharide, substrate and a crosslinking agent;
(ii) adding in the other of the keratinaceous substrate, the secondary proteinaceous substrate and the crosslinking agent to the mixture in (i); and
(iii) crosslinking the keratinaceous substrate and/or the secondary proteinaceous substrate with the crosslinking agent to form the bioplastic material.

Step (iii) may be performed before step (ii). Step (iii) may be facilitated by adjusting a pH of the mixture formed in step (ii).

An embodiment provides a method of forming a bioplastic material, comprising:
providing a eutectic melt comprising:
   keratin, and
   one or more of wheat flour, chitin and chitosan; and
crosslinking the keratin and the one or more of wheat flour, chitin and chitosan to form the bioplastic material.

A crosslinking agent may be included in the mixture.

An embodiment provides a method of forming a bioplastic material, comprising:
providing a eutectic melt comprising:
   keratin,
   one or more of wheat flour, chitin and chitosan, and
   a crosslinking agent; and
crosslinking the keratin and the one or more of wheat flour, chitin and chitosan with the crosslinking agent to form the bioplastic material.

An embodiment provides a bioplastic material formed using the method as set forth above.

A bioplastic material that is degradable to form a fertiliser comprising:
a first set of polymer chains comprising a keratinaceous substrate;
a second set of polymer chains comprising a biopolymer that includes one or more of an amine, hydroxyl and carboxyl group,
wherein one or more polymer chains of the first set of polymer chains and one or more polymer chains of the second set of polymer chains are crosslinked using citric acid.

An embodiment provides a bioplastic material comprising:
a first set of polymer chains comprising keratin;
a second set of polymer chains comprising a biopolymer that includes one or more of an amine, hydroxyl and carboxyl group,
wherein one or more polymer chains of the first set of polymer chains and one or more polymer chains of the second polymer chains are crosslinked.

An embodiment provides a bioplastic material comprising:
a first set of polymer chains comprising keratin;
a second set of polymer chains comprising a secondary protein and/or polysaccharide; and
a crosslinking agent linking one or more of the first polymer chains, the second polymer chains, and the first and second polymer chains.

An embodiment provides a bioplastic material, comprising:
keratin, and
one or more of wheat flour, chitin and chitosan; and
wherein one or more keratin polymer chains and one or more polymer chains of one or more of wheat flour, chitin and chitosan are crosslinked.

One or more embodiments of the disclosure may advantageously provide a bioplastic material that uses a waste stream as a feedstock.

### FIGURES

Embodiments will now be described by way of example only with reference to the accompanying non-limiting Figures, in which:

FIG. 1 schematically depicts an embodiment of a polymer network of a bioplastic material.

### DETAILED DESCRIPTION

An embodiment provides a method of forming a bioplastic material, comprising:
providing a mixture comprising: a keratinaceous substrate, and a secondary biopolymer substrate that includes one or more of an amine, hydroxyl and carboxyl group; and
crosslinking the keratinaceous substrate and the secondary biopolymer substrate to form the bioplastic material.

An embodiment provides a method of forming a bioplastic material, the method comprising: providing a mixture comprising a keratinaceous substrate; adding a secondary biopolymer or proteinaceous and/or polysaccharide substrate and a crosslinking agent to the mixture comprising the keratinaceous substrate; and crosslinking of the keratinaceous substrate and/or secondary proteinaceous substrate with the crosslinking agent to form the bioplastic material. Crosslinking may be facilitated by adjusting a pH of the mixture comprising the keratinaceous substrate.

An embodiment provides a method of forming a bioplastic material, comprising: providing a mixture comprising a keratinaceous substrate, a secondary proteinaceous and/or polysaccharide substrate and a crosslinking agent; and adjusting a pH of the mixture to promote crosslinking of the keratinaceous substrate and/or secondary biopolymer or proteinaceous and/or polysaccharide substrate with the crosslinking agent to form the bioplastic material.

The term “bioplastics” is used interchangeably with the term “biodegradable plastic” throughout this disclosure and are to mean a crosslinked polymeric material that is degradable by environmental and/or biological processes. Polymer chains of the bioplastic may be formed from biopolymers. In addition, or alternatively, the crosslinking agents or crosslinking locations may be degradable. For example, covalent bonds joining the crosslinking agent to a polymer chain may be degraded by hydrolysis.

The term “biopolymer” as used herein is to mean a polymer or mixture of polymers that are naturally derived, such as a protein, polysaccharide, and their derivatives which includes natural and synthetic derivates, such as chitosan and methyl cellulose. The biopolymer may be proteinaceous and/or polysaccharide-based. For example, a polysaccharide can include cellulose, starch and alginate, and chitin and its derivatives including chitosan, and a proteinaceous source includes collagen silk, fibrin, gelatine, and gluten. The term “biopolymer” as used herein also includes a mixture of one or more biopolymers. The term “secondary biopolymer substrate” as used herein is to mean a biopolymer that is different to a keratinaceous substrate.

The keratinaceous substrate may include any keratin source. The keratinaceous substrate may include derivatives of keratin. The derivates of keratin may be natural or synthetic. The keratinaceous substrate may include hair, scales, nails, feathers, horns, claws, and hooves. In an embodiment, the keratinaceous substrate includes wool. In an embodiment, the keratinaceous substrate is derived from wool. Wool used in an embodiment may be wool that is not suitable for other uses, such as the formation of garments. In an embodiment, the keratinaceous substrate includes keratin. The keratin may be derived from wool. The keratinaceous substrate may be provided as a solid, mixture or solution.

The step of providing the mixture may include dissolving the keratinaceous substrate in a eutectic mixture. The step of providing the mixture may include dissolving the secondary biopolymer substrate in a eutectic mixture. The keratinaceous substrate and the secondary biopolymer substrate may be dissolved in the same eutectic mixture. The keratinaceous substrate and the secondary biopolymer substrate may be dissolved at the same time or sequentially in the same eutectic mixture. The eutectic mixture may be a deep eutectic solvent. The eutectic mixture may comprise an ammonium salt. The ammonium salt may be a quaternary ammonium species. In an embodiment, the ammonium salt includes a choline halide. The choline halide may be choline chloride. The eutectic mixture may comprise a Lewis base. The Lewis base may include a urea-based species. The Lewis base may include a substituted urea species. The Lewis base may be urea.

In an embodiment, a w/w ratio of [quaternary ammonium salt]:[urea] ranges from 1:1000 to 1000:1. In an embodiment, a w/w ratio of [quaternary ammonium salt]:[urea] ranges from 1:100 to 100:1. In an embodiment, a w/w ratio of [quaternary ammonium salt]:[urea] ranges from 1:50 to 50:1. In an embodiment, a w/w ratio of [quaternary ammonium salt]:[urea] ranges from 1:10 to 10:1. In an embodiment, a w/w ratio of [quaternary ammonium salt]:[urea] ranges from 1:5 to 5:1. In an embodiment, a w/w ratio of [quaternary ammonium salt]:[urea] ranges from 1:2 to 2:1. In an embodiment, a w/w ratio of [quaternary ammonium salt]:[urea] is about 1:1.

The eutectic mixture may be heated to dissolve the keratinaceous substrate and/or secondary biopolymer substrate in the eutectic mixture. A temperature required to dissolve the keratinaceous substrate and/or secondary biopolymer substrate may depend on the keratinaceous substrate, the secondary biopolymer substrate and a composition of the eutectic mixture. The eutectic mixture may be heated to a temperature above 30° C. to dissolve the keratinaceous substrate and/or secondary biopolymer substrate. The eutectic mixture may be heated to a temperature above 40° C. to dissolve the keratinaceous substrate and/or secondary biopolymer substrate. The eutectic mixture may be heated to a temperature above 50° C. to dissolve the keratinaceous substrate and/or secondary biopolymer substrate. The eutectic mixture may be heated to a temperature above 75° C. to dissolve the keratinaceous substrate and/or secondary biopolymer substrate. The eutectic mixture may be heated to a temperature above 100° C. to dissolve the keratinaceous substrate and/or secondary biopolymer substrate. The eutectic mixture may be heated to a temperature above 125° C. to dissolve the keratinaceous substrate and/or secondary biopolymer substrate. The eutectic mixture may be heated to a temperature above 150° C. to dissolve the keratinaceous substrate and/or secondary biopolymer substrate. The eutectic mixture may be heated to a temperature above 175° C. to dissolve the keratinaceous substrate and/or secondary biopolymer substrate. The eutectic mixture may be heated to a temperature above 200° C. to dissolve the keratinaceous substrate and/or secondary biopolymer substrate.

The eutectic mixture may be heated up to a temperature of 50° C. to dissolve the keratinaceous substrate and/or secondary biopolymer substrate. The eutectic mixture may be heated up to a temperature of 75° C. to dissolve the keratinaceous substrate and/or secondary biopolymer substrate. The eutectic mixture may be heated up to a temperature of 100° C. to dissolve the keratinaceous substrate and/or secondary biopolymer substrate. The eutectic mixture may be heated up to a temperature of 125° C. to dissolve the keratinaceous substrate and/or secondary biopolymer substrate. The eutectic mixture may be heated up to a temperature of 150° C. to dissolve the keratinaceous substrate and/or secondary biopolymer substrate. The eutectic mixture may be heated up to a temperature of 175° C. to dissolve the keratinaceous substrate and/or secondary biopolymer substrate. The eutectic mixture may be heated up to a temperature of 200° C. to dissolve the keratinaceous substrate and/or secondary biopolymer substrate. The eutectic mixture may be heated up to a temperature of 250° C. to dissolve the keratinaceous substrate and/or secondary biopolymer substrate.

The method may further comprise drying the bioplastic material. Drying may include dehydration. Drying may include the use of an oven, a desiccator, critical point drier and/or freeze-drier. Drying may include the use of solvent substitution methods prior to remove any unreacted reactants, such as un-polymerised keratinaceous substrate, un-polymerised secondary biopolymer substrate, and/or unreacted crosslinking agent. An embodiment may comprise washing the bioplastic material to leach out any unreacted keratinaceous substrate, secondary biopolymer substrate, and if used the crosslinking agent, once the bioplastic material has formed. A plurality of washing steps may be used. Washing may use a polar or polar solvent. A polar solvent may include one or more of water, methanol and ethanol. Washing of the bioplastic material may occur before drying. The solvent(s) used for washing may be dependent upon the method used to dry the bioplastic material. For example, freeze-drying may require the use of water-based solvents for washing.

An embodiment may further comprise adding an additive to the mixture comprising the keratinaceous substrate prior to crosslinking. The additive may be used to modify a property of the resulting bioplastic material. For example, the additive may include one or more of a bulking agent, a plasticiser, a lubricating agent, a reinforcing agent, and water repellent. The bulking agent may include silica, talc, crushed mineral(s), and mineral powder(s). The bulking agent may reduce a density of the bioplastic. For example, the bulking agent may include foaming agents and low-density fillers. The bulking agent may increase a density of the bioplastic. The bulking agent may include a mechanical strength enabler, thermal strength enabler, and hardness enabler. In this way, the bulking agent may be used to adjust density, mechanical, thermal and hardness properties of the bioplastic. The bulking agent may include a clay-base material.

The additive may include a water-absorbing compound or material. The additive may include fertiliser. The additive may include a plant growth-promoter. The plant growth-promoter may be chemical or mineral. For example, the additive may include minerals or clays that improve soil health.

The plasticiser may include any compound that prevent restriction of polymer chains in the bioplastic material network. The plasticiser may include hydrophilic compounds, such as glycerine, ethylene glycol and ethylene glycol derivatives such as poly (ethylene glycol). The lubricating agent may include hydrophilic compounds or wetting agents. The lubricating agent may include glycerine. The reinforcing agent may be a fibrous material. The fibrous material may be in the form of strands, fibres and/or flocks. The reinforcing agent may act to improve mechanical properties of the bioplastic. The reinforcing agent may act as a scaffold. The reinforcing agent may include natural fibres. The reinforcing agent may include wool, cotton, sisal, coir, and hemp. The reinforcing agent may be a mixture of different fibres. For example, the reinforcing agent may be a mixture of cotton and sisal.

The mixture may comprise up to 1 wt. % fibrous material. The mixture may comprise up to 2 wt. % fibrous material. The mixture may comprise up to 3 wt. % fibrous material. The mixture may comprise up to 4 wt. % fibrous material. The mixture may comprise up to 5 wt. % fibrous material. The mixture may comprise up to 6 wt. % fibrous material. The mixture may comprise up to 7 wt. % fibrous material. The mixture may comprise up to 8 wt. % fibrous material. The mixture may comprise up to 9 wt. % fibrous material. The mixture may comprise up to 10 wt. % fibrous material. The mixture may comprise up to 11 wt. % fibrous material. The mixture may comprise up to 12 wt. % fibrous material. The mixture may comprise up to 13 wt. % fibrous material. The mixture may comprise up to 14 wt. % fibrous material. The mixture may comprise up to 15 wt. % fibrous material. The mixture may comprise up to 20 wt. % fibrous material. The mixture may comprise up to 25 wt. % fibrous material. The mixture may comprise up to 30 wt. % fibrous material. The mixture may comprise up to 40 wt. % fibrous material. The mixture may comprise up to 50 wt. % fibrous material. The mixture may comprise up to 60 wt. % fibrous material. The mixture may comprise up to 70 wt. % fibrous material. The mixture may comprise up to 80 wt. % fibrous material. The mixture may comprise up to 90 wt. % fibrous material. The mixture may comprise up to 100 wt. % fibrous material.

The mixture may comprise at least 1 wt. % fibrous material. The mixture may comprise at least 2 wt. % fibrous material. The mixture may comprise at least 3 wt. % fibrous material. The mixture may comprise at least 4 wt. % fibrous material. The mixture may comprise at least 5 wt. % fibrous material. The mixture may comprise at least 6 wt. % fibrous material. The mixture may comprise at least 7 wt. % fibrous material. The mixture may comprise at least 8 wt. % fibrous material. The mixture may comprise at least 9 wt. % fibrous material. The mixture may comprise at least 10 wt. % fibrous material. The mixture may comprise at least 11 wt. % fibrous material. The mixture may comprise at least 12 wt. % fibrous material. The mixture may comprise at least 13 wt. % fibrous material. The mixture may comprise at least 14 wt. % fibrous material. The mixture may comprise at least 15 wt. % fibrous material. The mixture may comprise at least 20 wt. % fibrous material. The mixture may comprise at least 25 wt. % fibrous material. The mixture may comprise at least 30 wt. % fibrous material. The mixture may comprise at least 40 wt. % fibrous material. The mixture may comprise at least 50 wt. % fibrous material. The mixture may comprise at least 60 wt. % fibrous material. The mixture may comprise at least 70 wt. % fibrous material. The mixture may comprise at least 80 wt. % fibrous material. The mixture may comprise at least 90 wt. % fibrous material. The mixture may comprise at least 100 wt. % fibrous material.

The water repellent may be a hydrophobic compound. The water repellent may increase a water resistance or reduce a water permeability of the bioplastic material. The terms “increase water resistance” and “reduce water permeability” are used throughout interchangeably to mean a material that is less able to absorb water compared to a material without the water repellent. The water repellent may include hydrocarbon compounds. The water repellent may include waxes and/or oils. The waxes may include carnauba wax. One or more of the bulking agent, plasticiser, lubricating agent, reinforcing agent and water repellent may be entrapped but otherwise not covalently bonded to one or more polymers of the polymer network of the bioplastic material. One or more of the bulking agent, plasticiser, lubricating agent, reinforcing agent and water repellent may be covalently bonded to one or more polymers of the polymer network of the bioplastic material. For example, the reinforcing agent may be surface-modified following crosslinking to be bonded, either covalently of non-covalently, such as by forming an amide linkage with a surface-available amine, to the keratinaceous substrate and/or secondary biopolymer substrate.

The additive may be become bonded to the polymer network that forms the bioplastic. The additive may be encapsulated or encased in the polymer network that forms the bioplastic. In an embodiment, the additive may leach out of the polymer network that forms the bioplastic. For example, if the additive is a fertilising agent, it may be beneficial for the fertilising agent to leach out over time.

The secondary biopolymer substrate may include one or more of an amide, oxmine, thiol, aldehyde and ketone group in addition to the one or more of an amine, hydroxyl and carboxyl group. The secondary biopolymer substrate may be a proteinaceous substrate or a polysaccharide-based substrate. The secondary biopolymer may be proteinaceous. The secondary biopolymer may be a mixture of one or more proteinaceous substrates. The secondary biopolymer may be polysaccharide-based. The secondary biopolymer may be a mixture of one or more polysaccharide substrates. The secondary biopolymer may be a mixture of one or more proteinaceous substrates and one or more polysaccharide substrates. In an embodiment, the secondary biopolymer substrate is grain-based, plant-based, vegetable-based, animal-based, algal-based, bacterial-based, and/or fungal-based. The grain-based biopolymer may be provided as a flour. The flour may be wheat flour. The secondary biopolymer substrate may be or include gluten. The plant-based and/or a vegetable-based secondary biopolymer substrate may be provided as a legume-based flour, such as mung bean or lupin flour. The animal-and/or fungal-based biopolymer substrate may include chitin. The animal-and/or fungal-based biopolymer substrate may include a derivative of chitin. In an embodiment, the secondary biopolymer substrate includes wheat flour and/or a chitin-based biopolymer. The chitin-based biopolymer includes chitin and derivatives of chitin. The derivative of chitin may be chitosan. A mixture of chitin and chitosan may be used as the secondary biopolymer substrate. In an embodiment, the secondary biopolymer substrate may also act as a bulking agent. Undissolved keratinaceous substrate and undissolved secondary biopolymer substrate may act as the reinforcing agent.

The mixture may comprise up to 1 wt. % secondary biopolymer substrate. The mixture may comprise up to 2 wt. % secondary biopolymer substrate. The mixture may comprise up to 3 wt. % secondary biopolymer substrate. The mixture may comprise up to 4 wt. % secondary biopolymer substrate. The mixture may comprise up to 5 wt. % secondary biopolymer substrate. The mixture may comprise up to 6 wt. % biopolymer. The mixture may comprise up to 7 wt. % secondary biopolymer substrate. The mixture may comprise up to 8 wt. % biopolymer. The mixture may comprise up to 9 wt. % secondary biopolymer substrate. The mixture may comprise up to 10 wt. % biopolymer. The mixture may comprise up to 11 wt. % secondary biopolymer substrate. The mixture may comprise up to 12 wt. % biopolymer. The mixture may comprise up to 13 wt. % secondary biopolymer substrate. The mixture may comprise up to 14 wt. % biopolymer. The mixture may comprise up to 15 wt. % secondary biopolymer substrate. The mixture may comprise up to 20 wt. % secondary biopolymer substrate. The mixture may comprise at least 1 wt. % secondary biopolymer substrate. The mixture may comprise at least 2 wt. % secondary biopolymer substrate. The mixture may comprise at least 3 wt. % secondary biopolymer substrate. The mixture may comprise at least 4 wt. % biopolymer. The mixture may comprise at least 5 wt. % secondary biopolymer substrate. The mixture may comprise at least 6 wt. % secondary biopolymer substrate. The mixture may comprise at least 7 wt. % secondary biopolymer substrate. The mixture may comprise at least 8 wt. % secondary biopolymer substrate. The mixture may comprise at least 9 wt. % secondary biopolymer substrate. The mixture may comprise at least 10 wt. % secondary biopolymer substrate. The mixture may comprise at least 11 wt. % secondary biopolymer substrate. The mixture may comprise at least 12 wt. % secondary biopolymer substrate. The mixture may comprise at least 13 wt. % secondary biopolymer substrate. The mixture may comprise at least 14 wt. % secondary biopolymer substrate. The mixture may comprise at least 15 wt. % secondary biopolymer substrate.

The method may include providing a crosslinking agent. The mixture of the keratinaceous substrate and the secondary biopolymer substrate may include the crosslinking agent. The crosslinking agent may be dissolved in the mixture comprising the keratinaceous substrate, and the secondary biopolymer substrate. The step of crosslinking the keratinaceous substrate and the secondary biopolymer substrate may comprise adjusting a pH of the mixture to promote crosslinking with the crosslinking agent. In an embodiment, the secondary biopolymer substrate acts as a crosslinking agent. For example, if the secondary biopolymer substrate includes a polysaccharide having carboxyl groups, the carboxyl groups may form amide linkages with the keratinaceous substrate. In embodiments where the secondary biopolymer substrate acts as a crosslinking agent, the secondary biopolymer includes moieties that are capable of reacting with moieties on the keratinaceous substrate such as amines.

In an embodiment, a w/w ratio of [crosslinking agent]:[keratinaceous substrate] ranges from 1:1000 to 1000:1. In an embodiment, a w/w ratio of [crosslinking agent]:[keratinaceous substrate] ranges from 1:100 to 100:1. In an embodiment, a w/w ratio of [crosslinking agent]:[keratinaceous substrate] ranges from 1:50 to 50:1. In an embodiment, a w/w ratio of [crosslinking agent]:[keratinaceous substrate] ranges from 1:10 to 10:1. In an embodiment, a w/w ratio of [crosslinking agent]:[keratinaceous substrate] ranges from 1:5 to 5:1. In an embodiment, a w/w ratio of [crosslinking agent]:[keratinaceous substrate] ranges from 1:2 to 2:1. In an embodiment, a w/w ratio of [crosslinking agent]:[keratinaceous substrate] is about 1:1. Adjusting a ratio of [crosslinking agent]:[keratinaceous substrate] may affect properties of the resulting bioplastic material. For example, increasing a ratio of the crosslinking agent to the keratinaceous substrate may increase a stiffness of the bioplastic material. Increasing a ratio of the crosslinking agent to the keratinaceous substrate may decrease a water content of the bioplastic material. Reducing a ratio of the crosslinking agent to the keratinaceous substrate may increase the water content of the bioplastic material.

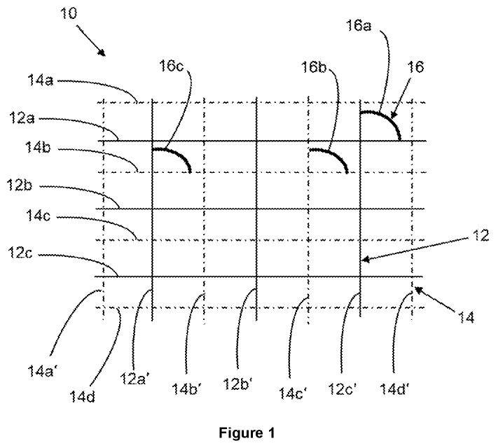

The crosslinking agent may be covalently bonded to the keratinaceous substrate, the secondary biopolymer substrate, or both the keratinaceous substrate and secondary biopolymer substrate. For example, as shown in FIG. 1, a bioplastic material has a polymer network 10 of keratinaceous polymer chains 12, secondary biopolymer polymer chains 14, and crosslinking agents 16. In an embodiment, the keratinaceous polymer chains 12 are in the form of keratin. In an embodiment, the secondary biopolymer polymer chains 14 are in the form of gluten. In an embodiment, the secondary biopolymer polymer chains 14 are in the form of chitin or a chitin derivative. Crosslinking agent 16a is bonded to adjacent keratinaceous polymer chains 12a and 12c′. Crosslinking agent 16b is bonded to adjacent secondary proteinaceous polymer chains 14b and 14c′. Crosslinking agent 16c is bonded at one end to a keratinaceous polymer chain 12a′ and at another end a secondary proteinaceous polymer chain 14b. The polymer network 10 depicted in FIG. 1 is schematic only and does not limit the scope of the disclosure to any specific polymer architecture. Additives including one or more of a bulking agent, a plasticiser, a lubricating agent, a reinforcing agent and a water repellent are not depicted in polymer network 10.

If used, the crosslinking agent may preferentially bond to one of the keratinaceous polymer chains or biopolymer polymer chains. The crosslinking agent may include a di-carboxyl species, a di-amino species, di-epoxy species, a di-hydroxyl species, and/or a species having two from a list including an amino group, a hydroxyl group, an epoxy group, and a carboxyl group. The crosslinking agent may include more than one type of crosslinking agent. For example, the crosslinking agent may include a di-carboxyl species and a di-amino species. The crosslinking agent may form an amide bond with polymer chains of the keratinaceous substrate and/or polymer chains of the secondary biopolymer substrate. The crosslinking agent may form an ester bond with polymer chains of the keratinaceous substrate and/or polymer chains of the secondary biopolymer substrate. The crosslinking agent may form an ether bond with polymer chains of the keratinaceous substrate and/or polymer chains of the secondary biopolymer substrate. The crosslinking agent may form a hydrogen bond with polymer chains of the keratinaceous substrate and/or polymer chains of the secondary biopolymer substrate. The crosslinking agent may form two or more of an amine, amide, ester or ether bond with the keratinaceous polymer chains and/or biopolymer polymer chains. In an embodiment, the crosslinker includes citric acid. In an embodiment, the crosslinker includes glycerol diglycidyl ether, trimethylolpropane triglycidyl ether, and polyethylene glycol digycidyl ether. Glutaraldehyde has been used to form crosslinked plastic materials. However, glutaraldehyde is toxic, which limits its widespread use, especially for biodegradable plastic materials.

The mixture may comprise up to 1 wt. % crosslinking agent. The mixture may comprise up to 2 wt. % crosslinking agent. The mixture may comprise up to 3 wt. % crosslinking agent. The mixture may comprise up to 4 wt. % crosslinking agent. The mixture may comprise up to 5 wt. % crosslinking agent. The mixture may comprise up to 6 wt. % crosslinking agent. The mixture may comprise up to 7 wt. % crosslinking agent. The mixture may comprise up to 8 wt. % crosslinking agent. The mixture may comprise up to 9 wt. % crosslinking agent. The mixture may comprise up to 10 wt. % crosslinking agent. The mixture may comprise up to 11 wt. % crosslinking agent. The mixture may comprise up to 12 wt. % crosslinking agent. The mixture may comprise up to 13 wt. % crosslinking agent. The mixture may comprise up to 14 wt. % crosslinking agent. The mixture may comprise up to 15 wt. % crosslinking agent. The mixture may comprise up to 20 wt. % crosslinking agent. The mixture may comprise at least 1 wt. % crosslinking agent. The mixture may comprise at least 2 wt. % crosslinking agent. The mixture may comprise at least 3 wt. % crosslinking agent. The mixture may comprise at least 4 wt. % crosslinking agent. The mixture may comprise at least 5 wt. % crosslinking agent. The mixture may comprise at least 6 wt. % crosslinking agent. The mixture may comprise at least 7 wt. % crosslinking agent. The mixture may comprise at least 8 wt. % crosslinking agent. The mixture may comprise at least 9 wt. % crosslinking agent. The mixture may comprise at least 10 wt. % crosslinking agent. The mixture may comprise at least 11 wt. % crosslinking agent. The mixture may comprise at least 12 wt. % crosslinking agent. The mixture may comprise at least 13 wt. % crosslinking agent. The mixture may comprise at least 14 wt. % crosslinking agent. The mixture may comprise at least 15 wt. % crosslinking agent.

The crosslinking agent may also act as a plasticiser. For example, glycerol diglycidyl ether, trimethylolpropane triglycidyl ether, and polyethylene glycol digycidyl ether can act as both a crosslinking agent and a plasticiser. In embodiments where the crosslinking agent also acts as a plasticiser, the plasticising crosslinking agent can be used in addition to a plasticising agent.

In an embodiment, a w/w ratio of [keratinaceous substrate]:[secondary biopolymer substrate] ranges from 1:100 to 100:1. In an embodiment, a w/w ratio of [keratinaceous substrate]:[secondary biopolymer substrate] ranges from ranges from 1:1000 to 1000:1. In an embodiment, a w/w ratio of [keratinaceous substrate]:[secondary biopolymer substrate] ranges from 1:100 to 100:1. In an embodiment, a w/w ratio of [keratinaceous substrate]:[secondary biopolymer substrate] ranges from 1:50 to 50:1. In an embodiment, a w/w ratio of t [keratinaceous substrate]:[secondary biopolymer substrate] ranges from 1:10 to 10:1. In an embodiment, a w/w ratio of [keratinaceous substrate]:[secondary biopolymer substrate] ranges from 1:5 to 5:1. In an embodiment, a w/w ratio of [keratinaceous substrate]:[secondary biopolymer substrate] ranges from 1:2 to 2:1. In an embodiment, a w/w ratio of [keratinaceous substrate]:[secondary biopolymer substrate] is about 1:1.

In an embodiment, the step of adjusting the pH of the mixture to promote crosslinking to form the bioplastic material is dependent upon the type of crosslinking agent, the type of keratinaceous substrate, and the type of secondary biopolymer substrate. A PH value that promotes crosslinking may be dependent upon a pKa of the crosslinking agent, the type of keratinaceous substrate, and/or the type of secondary biopolymer substrate. In an embodiment, adjusting the pH to promote crosslinking includes adjusting the pH to be ≥7.0. The pH may be adjusted by adding an acid. The acid may be a mineral acid and/or organic acid. The pH may be adjusted by adding a base. The base may be a mineral base and/or an organic base. In an embodiment, the pH is adjusted after addition of the crosslinking agent to the mixture of the keratinaceous substrate the secondary biopolymer substrate. In an embodiment, the pH is adjusted prior to addition of the crosslinking agent to the mixture of the keratinaceous substrate the secondary biopolymer substrate. Crosslinking may be base-catalysed crosslinking. Cross-linking may occur from the formation of a reaction involving an epoxy-amine, epoxy-hydroxyl or epoxy-carboxyl crosslinking. The resulting crosslinks may be amide, ether and/or ester bonds.

The mixture comprising the keratinaceous substrate, the secondary biopolymer substrate, and the crosslinking agent if used, may have a pH adjusted prior to addition of the keratinaceous substrate, the secondary biopolymer substrate and the crosslinking agent. For example, the mixture may comprise the keratinaceous substrate and the secondary biopolymer substrate, the pH may be adjusted, and then the crosslinking agent may be added to the mixture. In an embodiment of the method, the order of addition of the various components may include one or more of the following:
1. dissolving the keratinaceous substrate, the secondary biopolymer substrate and optionally a crosslinking agent to form the mixture, then adjusting the pH;
2. dissolving the keratinaceous substrate and the secondary biopolymer substrate to form the mixture, adjusting the pH, then dissolving the crosslinking agent;
3. dissolving the keratinaceous substrate and the crosslinking agent to form the mixture, adjusting the pH, and then dissolving the secondary biopolymer substrate;
4. dissolving the secondary biopolymer substrate and the crosslinking agent to form the mixture, adjusting the pH, and dissolving or adding the keratinaceous substrate.

Each component may be added from a solution, such as a stock solution. In an embodiment, the crosslinking agent is added to the mixture prior to adjusting the pH.

An embodiment provides a method of forming a bioplastic material, comprising:
(i) providing a mixture comprising one of a keratinaceous substrate, a secondary biopolymer substrate and a crosslinking agent;
(ii) mixing in the other of the keratinaceous substrate, the secondary biopolymer substrate and the crosslinking agent; and
(iii) adjusting a pH of the mixture to promote crosslinking of the keratinaceous substrate and/or the secondary biopolymer substrate with the crosslinking agent to form the bioplastic material.

Step (iii) may be performed before step (ii)

Prior to crosslinking, the mixture comprising a keratinaceous substrate, a biopolymer proteinaceous substrate and optionally the crosslinking agent may be placed in a mould to form a moulded bioplastic material. For example, the mixture comprising the keratinaceous substrate, the secondary biopolymer substrate and optionally the crosslinking agent may be placed into the mould before or after the pH is adjusted.

The moulded bioplastic material may be dried in the mould.

The keratinaceous substrate may be first dissolved in a eutectic mixture prior to the addition of the secondary biopolymer substrate. In an embodiment, the crosslinking agent is dissolved in the eutectic mixture prior to the keratinaceous and/or secondary biopolymer substrate. In an embodiment, the crosslinking agent is dissolved in the eutectic mixture after dissolution of the keratinaceous and/or secondary biopolymer substrate. A co-solvent may be used to form the mixture comprising the keratinaceous substrate and the secondary biopolymer substrate. The co-solvent may be a polar solvent or a non-polar solvent. The co-solvent may be organic-based or aqueous-based. The co-solvent may include an ionic liquid. The organic-based co-solvent may include two or more organic solvents. The aqueous-based co-solvent may include one or more solutes. In an embodiment, the co-solvent includes water. The water may be distilled water.

The method may further comprise heating the mixture of the keratinaceous substrate and the secondary biopolymer substrate to form the bioplastic material. If a crosslinking agent is included in the mixture of the keratinaceous substrate and the secondary biopolymer substrate, heating may occur prior to or after the addition of the crosslinking agent. The step of heating and drying may be performed simultaneously. The mixture of keratinaceous substrate, secondary biopolymer substrate may be placed in a mould. The mould may be heated to form the bioplastic material.

Heating the mixture of the keratinaceous substrate and the secondary biopolymer substrate to form the bioplastic material may be performed at a temperature greater than 30° C. Heating the mixture of the keratinaceous substrate and the secondary biopolymer substrate to form the bioplastic material may be performed at a temperature greater than 40° C. Heating the mixture of the keratinaceous substrate and the secondary biopolymer substrate to form the bioplastic material may be performed at a temperature greater than 50° C. Heating the mixture of the keratinaceous substrate and the secondary biopolymer substrate to form the bioplastic material may be performed at a temperature greater than 60° C. Heating the mixture of the keratinaceous substrate and the secondary biopolymer substrate to form the bioplastic material may be performed at a temperature greater than 70° C. Heating the mixture of the keratinaceous substrate and the secondary biopolymer substrate to form the bioplastic material may be performed at a temperature greater than 80° C. Heating the mixture of the keratinaceous substrate and the secondary biopolymer substrate to form the bioplastic material may be performed at a temperature greater than 90° C. Heating the mixture of the keratinaceous substrate and the secondary biopolymer substrate to form the bioplastic material may be performed at a temperature greater than 100° C.

The mixture of the keratinaceous substrate and the secondary biopolymer substrate may be heated up to a temperature of 100° C. to form the bioplastic material. The mixture of the keratinaceous substrate and the secondary biopolymer substrate and the crosslinking agent may be heated up to a temperature of 90° C. to form the bioplastic material. The mixture of the keratinaceous substrate and the secondary biopolymer substrate may be heated up to a temperature of 80° C. to form the bioplastic material. The mixture of the keratinaceous substrate and the secondary biopolymer substrate may be heated up to a temperature of 70° C. to form the bioplastic material. The mixture of the keratinaceous substrate and the secondary biopolymer substrate may be heated up to a temperature of 60° C. to form the bioplastic material. The mixture of the keratinaceous substrate and the secondary biopolymer substrate may be heated up to a temperature of 50° C. to form the bioplastic material. The mixture of the keratinaceous substrate and the secondary biopolymer substrate may be heated up to a temperature of 40° C. to form the bioplastic material.

Reference to processing the mixture of the keratinaceous substrate and the secondary biopolymer substrate, such as heating, adjusting a pH, pouring into a mould, and so on, may also apply to embodiments where a crosslinking agent is included in the mixture of the keratinaceous substrate and the secondary biopolymer substrate.

An embodiment provides a bioplastic formed using an embodiment of the method as set forth above.

An embodiment provides a bioplastic comprising: a set of first polymer chains comprising keratin; a second set of polymer chains comprising a secondary biopolymer that includes one or more of an amine, hydroxyl and carboxyl group; wherein one or more polymer chains of the first polymer chains and one or more polymer chains of the second set of polymer chains are crosslinked.

By way of explanation only with reference to FIG. 1, the first set of polymer chains are shown schematically as keratin polymer chains 12 and the second set of polymer chains are shown schematically as secondary biopolymer polymer chains 14. In an embodiment, the secondary biopolymer chains are in the form of gluten. In an embodiment, the secondary biopolymer chains are a polysaccharide. In an embodiment, the secondary biopolymer chains are in the form of chitin and/or chitosan. In an embodiment, the keratinaceous polymer chains are in the form of keratin. As shown in FIG. 1, the first set of polymer chains 12 have a number of polymer chains 12a-12c in a first orientation and polymer chains 12a′-12c′ in a second orientation, and the second set of polymer chains 12 have a number of polymer chains 14a-14d in a first orientation and polymer chains 14a′-14d′ in a second orientation. The first and second orientations of the polymer chains are schematic only and the polymer network 10 could have any number of polymer chain orientations and shape, for the first and second set of polymer chains 12 and 14. Adjacent polymer chains are crosslinked by crosslinking agent 16.

In an embodiment, the polymeric material has a water content of 6.9%. The bioplastic material may be a rubbery material. The bioplastic may be used in consumer goods, pharmaceutical and medical goods, and medical device such as medial implants. The medical implants may be biodegradable. The bioplastic may be used as a biodegradable coating.

Degradation products of an embodiment of the disclosed bioplastic may act as a fertiliser for plants. For example, degradation of keratin may help to provide amino acids and other nitrogen-containing compounds used by plants. In an embodiment, the bioplastic may be chopped or shredded and used as a slow-release fertiliser.

An embodiment provides a pot plant formed from the bioplastic as set forth above. The pot plant itself may act as a slow-release fertiliser.

In the claims which follow and in the preceding description of the disclosure, except where context requires otherwise due to expressed language or necessary implications, the word “comprise” or variants such as “comprises” or “comprising” is used in an inclusive sense i.e. to specify the presence of the state features but not to preclude the presence or addition of further features in various embodiments

### EXAMPLES

Embodiments of the disclosure will now be described with reference to the following Examples. A summary of the Samples and Comparative Samples in the Examines is outlined in Table 1.

### Sample 1

Choline chloride (46 g) and urea (46 g) were mixed to form a eutectic melt mixture. Wool (5 g) was added to the eutectic melt mixture followed be heating at 150° C. to dissolve the wool in the eutectic melt mixture. Water (10 mL) and citric acid (4 g) were mixed into the eutectic melt mixture, followed by potassium hydroxide (bring up pH to 7.2) and wheat flour (5 g). The eutectic melt mixture was poured into a mould, in this case a glass cup, then dried overnight at 60° C., and then washed with water to form a rubbery polymeric material. The polymeric material had a water content of 6.9%.

### Sample 2

Choline chloride (46 g) and urea (46 g) were mixed to form a eutectic melt mixture. Wool (5 g) was added to the eutectic melt mixture followed be heating at 150° C. to dissolve the wool in the eutectic melt mixture. Water (10 mL) and citric acid (4 g) were mixed into the eutectic melt mixture, followed by potassium hydroxide (bring up pH to 7.2), wheat flour (5 g), and glycerine (5 mL). The eutectic melt mixture was poured into a mould then dried overnight at 60° C., and then washed with water to form a rubbery bioplastic material that has a surface with decreased surface friction and more pliable compared to Sample 1.

### Sample 3

Choline chloride (46 g) and urea (46 g) were mixed to form a eutectic melt mixture. Wool (5 g) was added to the eutectic melt mixture followed be heating at 150° C. to dissolve the wool in the eutectic melt mixture. Water (10 mL) and citric acid (4 g) were mixed into the eutectic melt mixture, followed by potassium hydroxide (bring up pH to 7.2), wheat flour (5 g), and silica (20 g). The eutectic melt mixture was poured into a mould then dried overnight at 60° C., and then washed with water to form a rubbery bioplastic material that has increased hardness, thermal strength and mechanical stability compared to Sample 1.

### Sample 4

Choline chloride (46 g) and urea (46 g) were mixed to form a eutectic melt mixture. Wool (5 g) was added to the eutectic melt mixture followed be heating at 150° C. to dissolve the wool in the eutectic melt mixture. Water (10 mL) and citric acid (4 g) were mixed into the eutectic melt mixture, followed by potassium hydroxide (bring up pH to 7.2), wheat flour (5 g), and carnuba wax (10 g). The eutectic melt mixture was poured into a mould then dried overnight at 60° C., and then washed with water to form a rubbery bioplastic material that has increased water resistance compared to Sample 1.

### Sample 5

Choline chloride (46 g) and urea (46 g) were mixed to form a eutectic melt mixture. Wool (5 g) was added to the eutectic melt mixture followed be heating at 150° C. to dissolve the wool in the eutectic melt mixture. Water (10 mL) and citric acid (4 g) were mixed into the eutectic melt mixture, followed by potassium hydroxide (bring up pH to 7.2), wheat flour (5 g), and one or more of glycerine (5 mL), silica (20 g) and carnuba wax (10 g). The eutectic melt mixture was poured into a mould then dried overnight at 60° C., and then washed with water to form a rubbery polymeric material that has a more rubbery and pliable texture with increased hardness, thermal strength and mechanical properties, and a lower water permeability compared to Sample 1.

### Sample 6

Choline chloride (50 g) and urea (200 g) were mixed to form a eutectic melt mixture. Wool (25 g) was added to the eutectic melt mixture followed be heating at 150° C. to dissolve the wool in the eutectic melt mixture. The eutectic mixture was allowed to cool to 60° C. Water (50 mL) and citric acid (5 g) were mixed into the eutectic melt mixture, followed by carnauba wax (2 g), wheat flour (100 g), talc (10 g), and pro ball clay powder (10 g). The eutectic mixture was placed into a mould and dried in a desiccator to dry.

### Sample 7

Sample 6 was prepared, but chitin or chitosan was added (up to 10 wt. %) during addition of water.

### Sample 8

Sample 6 was prepared, but chitin or chitosan was added (up to 10 wt. %) during addition of water, and wheat flour and carnauba wax were omitted.

### Sample 9

Sample 6 was prepared, but chitin or chitosan was added (up to 10 wt. %) during addition of water, and citric acid was replaced with glycerol diglycidyl ether (up to 10 wt. %). Glycerol diglycidyl ether can optionally be replaced with trimethylolpropane triglycidyl ether or polyethylene glycol digycidyl ether

### Sample 10

Sample 1 or sample 6 was prepared, but a fibrous material (up to 25 wt %), such as wool, cotton, sisal, and/or hemp, was added during addition of citric acid or during mixing following addition of water.

### Comparative Sample 1

Choline chloride (46 g) and urea (46 g) were mixed to form a eutectic melt mixture. Wool (5 g) was added to the eutectic melt mixture followed be heating at 150° C. to dissolve the wool in the eutectic melt mixture. Water (10 mL) and citric acid (4 g) were mixed into the eutectic melt mixture, followed by potassium hydroxide (bring up pH to 7.2). The eutectic melt mixture was poured into a mould then dried overnight at 60° C. to form a brittle brown-red polymer.

The absence of wheat flour causes the polymer to become brittle.

### Comparative Sample 2

Choline chloride (46 g) and urea (46 g) were mixed to form a eutectic melt mixture. Wool (5 g) was added to the eutectic melt mixture followed be heating at 150° C. to dissolve the wool in the eutectic melt mixture. Water (10 mL) and citric acid (4 g) were mixed into the eutectic melt mixture, followed by potassium hydroxide (bring up pH to 7.2) and coconut flour (5 g) or tapioca flour (5 g). Drying the eutectic melt mixture overnight at 60° C. in a mould did not form a rubbery polymeric material.

The use of flour with little to no protein content did not result in the formation of a polymeric material with properties similar to Sample 1.

### Comparative Sample 3

Choline chloride (46 g) and urea (46 g) were mixed to form a eutectic melt mixture. Water (10 mL) and citric acid (4 g) were mixed into the eutectic melt mixture, followed by potassium hydroxide (bring up pH to 7.2). Drying the eutectic melt mixture overnight at 60° C. in a mould did not result in the formation of a polymeric material.

The absence of wool and wheat flour did not result in the formation of a polymeric material with properties similar to Sample 1.

### Comparative Sample 4

Keratin powder (5 g) was mixed with water (10 mL) and citric acid (4 g), followed by the addition of potassium hydroxide (bring up pH to 7.2). Drying the mixture overnight at 60° C. in a mould and then washing with water formed a thick foamy material.

The absence of a eutectic melt and wheat flour did not result in the formation of a polymeric material with properties similar to Sample 1.

### Comparative Sample 5

Keratin powder (5 g) was mixed with water (10 mL) and glutaraldehyde (5 mL), followed by the addition of potassium hydroxide (bring up pH to 7.2). Drying the mixture overnight at 60° C. in a mould and then washing with water formed a brittle polymeric material.

### Comparative Sample 6

Wheat flour (5 g) was mixed with water (10 mL) and glutaraldehyde (5 mL), followed by the addition of potassium hydroxide (bring up pH to 7.2). Drying the mixture overnight at 60° C. in a mould and then washing with water formed a brittle polymeric material.

TABLE 1
Overview of composition and properties of the Samples and Comparative Samples.

| | Eutectic | | Wheat | Citric | | | | Carnauba | |
|---|---|---|---|---|---|---|---|---|---|
| Sample | melt | Wool | flour | acid | KOH | Glycerine | Silica | wax | GA* |
| Sample 1 | Yes | Yes | Yes | Yes | Yes | — | — | — | — |
| Sample 2 | Yes | Yes | Yes | Yes | Yes | Yes | — | — | — |
| Sample 3 | Yes | Yes | Yes | Yes | Yes | — | Yes | — | — |
| Sample 4 | Yes | Yes | Yes | Yes | Yes | — | — | Yes | — |
| Sample 5 | Yes | Yes | Yes | Yes | Yes | Yes | Yes | Yes | — |
| Sample 6 | Yes | Yes | Yes | Yes | — | — | — | Yes | — |
| Sample 7 | Yes | Yes | Yes | Yes | — | — | — | Yes | — |
| Sample 8 | Yes | Yes | — | Yes | — | — | — | — | — |
| Sample 9 | Yes | Yes | Yes | — | — | — | — | — | — |
| Sample 10 | Yes | Yes | Yes | Yes | — | — | — | Yes | — |
| Comparative Sample 1 | Yes | Yes | — | Yes | Yes | — | — | — | — |
| Comparative Sample 2 | Yes | Yes | — | Yes | Yes | — | — | — | — |
| Comparative Sample 3 | Yes | — | — | Yes | Yes | — | — | — | — |
| Comparative Sample 4 | — | Yes | — | Yes | Yes | — | — | — | — |
| Comparative Sample 5 | — | Yes | — | — | Yes | — | — | — | Yes |
| Comparative Sample 6 | — | — | Yes | — | Yes | — | — | — | Yes |

| | | Clay | Chitin/ | | Fibrous | |
|---|---|---|---|---|---|---|
| Sample | Talc | power | chitosan | Epoxide | material | Material Properties\hat{ } |
| Sample 1 | — | — | — | — | — | Flexible material |
| Sample 2 | — | — | — | — | — | Flexible material |
| Sample 3 | — | — | — | — | — | Flexible material |
| Sample 4 | — | — | — | — | — | Flexible material |
| Sample 5 | — | — | — | — | — | Flexible material |
| Sample 6 | Yes | Yes | — | — | — | Less Flexible-strong |
| | | | | | | material |
| Sample 7 | Yes | Yes | Yes | — | — | Less Flexible-stronger |
| | | | | | | material |
| Sample 8 | Yes | Yes | Yes | — | — | Less Flexible-stronger |
| | | | | | | material |
| Sample 9 | Yes | Yes | Yes | Yes | — | Less Flexible-stronger |
| | | | | | | material |
| Sample 10 | Yes | Yes | — | — | Yes | Less Flexible-stronger |
| | | | | | | material |
| Comparative Sample 1 | — | — | — | — | — | Brittle material |
| Comparative Sample 2 | — | — | — | — | — | Not formed |
| Comparative Sample 3 | — | — | — | — | — | Not formed |
| Comparative Sample 4 | — | — | — | — | — | Thick foam |
| Comparative Sample 5 | — | — | — | — | — | Brittle material |
| Comparative Sample 6 | — | — | — | — | — | Brittle material |

*GA = glutaraldehyde;
\hat{ }properties relative to other samples.

1.-39. (canceled)

40. A bioplastic material that is degradable to form a fertilizer comprising:
a first set of polymer chains comprising a keratinaceous substrate;
a second set of polymer chains comprising a biopolymer that includes one or more of an amine, hydroxyl and carboxyl group,
wherein one or more polymer chains of the first set of polymer chains and one or more polymer chains of the second set of polymer chains are crosslinked using citric acid.

41. The bioplastic material as claimed in claim 40, wherein the keratinaceous substrate is derived from wool.

42. The bioplastic material as claimed in claim 40, wherein the citric acid links one or more polymers of the first set of polymer chains, one or more polymers of the second set of polymer chains, and/or one or more polymers of the first set of polymer chains and second set of polymer chains.

43. The bioplastic material as claimed in claim 40, wherein a w/w ratio of [citric acid]:[keratinaceous substrate] ranges from 1:1000 to 1000:1.

44. The bioplastic material as claimed in claim 40, further comprising an additive including one or more of a bulking agent, a plasticiser, a lubricating agent, a reinforcing agent and a water repellent.

45. The bioplastic material as claimed in claim 44, wherein the bulking agent includes silica, the plasticiser includes glycerine, the lubricating agent includes glycerine, the reinforcing agent includes a fibrous material, the water repellent includes a wax.

46. The bioplastic material as claimed in claim 40, wherein a w/w ratio of [keratinaceous substrate]:[biopolymer] ranges from 1:100 to 100:1.

47. The bioplastic material as claimed in claim 40, wherein the biopolymer is grain-based, plant-based, vegetable-based, animal-based, algal-based, bacterial-based, and/or fungal-based.
